(19) United States
(12) Patent Application Publication
(10) Pub. No.: US 2018/0139944 A1
(43) Pub. Date: May 24, 2018

(54) Flexible 'quiver' style holder and carrier of pre-tied fishing hooks and leaders.

(71) Applicant: Jade River, Agassiz (CA)

(72) Inventor: Jade River, Agassiz (CA)

(21) Appl. No.: 15/357,275

(22) Filed: Nov. 21, 2016

(51) Int. Cl. A01K 97/06; A45F 3/00

(52) U.S. Cl. CPC A01K 97/06; A45F 3/005

(57) ABSTRACT

A flexible ‘quiver’ style carrier and holder, in the shape of an elongated funnel, for pre-tied hooks and leaders while fishing especially when, but not limited to, river run salmon. This holder solves the problem of leaders being kinked by wrapping on a planar surface or curling from being wrapped in a circular or cylindrical fashion. The holder is extremely light weight and waterproof as it is proposed to be made of a high density closed cell foam that is flexible and carried by means of removable, adjustable shoulder strap. The hooks are embedded into the top rim of the mouth and the leaders hang inside the quiver where they are protected from entanglement within the holder, and protected from dense brush found when walking to fishing sites.

The body lower end remains open allowing slightly longer leaders to protrude without being kinked by inner blockage. It also allows free flow of rainwater that may fall into the mouth of the holder.

The carrier strap or sleeve is completely removable for the loading the holder by way of the full length slice in the sidewall. To minimize wear on the access slice, a fork-like tool is used to guide the leader filaments into the holder along the slice.

### BACKGROUND OF THE INVENTION

The Background of the invention is regarding sport fishing, particularly when, but not limited to, river run salmon, and the necessity to minimize the time tying and baiting hooks while at the fishing sight.

The act of fishing becomes more popular every year. During river run salmon season there are times when you are less than 3 ft. between anglers competing for the opportunity to catch fish. The fish return in intermittent schools and after losing your leader to a rock or log debris, the time taken to re-tie the leaders can be the difference between intercepting the school passing, or missing it entirely.

It is common knowledge that having pre-tied leaders ready before you go to a fishing site has been on the minds of anglers for many, many years. Plate-like wrapping devices kink the leader filaments and circular wrapping devices leave a distinct curl in the leader filaments. When I was a child 50 years ago we had an aluminum plate with a series of hooks and springs to store and carry pre-tied leaders. Many patents have been issued since for complicated devices doing much the same function as this invention, however this configuration is unique in its simplicity.

The salmon return extends into the colder weather of September, October, November and December, and it very often is best for fishing during heavy rains. The ability to replace lost leaders and hooks quickly and without moving back to shore thereby leaving your chosen spot, greatly increases the chance for a successful outcome during the fishing time. The invention also greatly reduces the effect of wet, cold weather on hands when at the fishing site.

This invention allows an angler greater opportunity to remain in their chosen fishing spot and increases the time actually fishing.

### SUMMARY OF THE INVENTION

An Invention that stores. carries, and dispenses pre-tied fishing hooks and leaders.

This invention solves many issues with previous inventions designed to perform a similar function, particularly the kinking and curling of pre-tied hooks and leaders.

The invention greatly increases the speed at which leaders can be changed and increases fishing time and mitigates the effect of cold, wet weather on hands while tying leaders at the fishing site.

The invention reduces the amount of bulk in fishing vests and eliminates the need to extricate box or card type leader holders which are at risk of being dropped and washed away.

The configuration offers an almost ‘hands free’ access to the pre-tied leaders, as in drawing an arrow from a quiver.

The top 4 inches of the holder is flared to accommodate an increased amount of hooks. A common fish attractant used is short pieces of wool and plastic salmon eggs. Whereas a single, pre-tied hook and leader requires a finite amount of space, the plurality of hooks allowed on the mouth rim would amount to approximately 30 hooks.

Whereas a pre-baited hook requires a 10% to 30% increase in the required space in the mouth, the plurality of hooks would be approximately 15 hooks. Though increasing the size of the space needed for each pre-baited hook, it further increases the time spent actually fishing. The increased mouth diameter also will accommodate lure-type fish presentations.

The body lower length is reduced in diameter to reduce bulk and weight as only line filaments are present.

The body lower end remains open allowing slightly longer leaders to protrude without being kinked by inner blockage.

The invention is water proof and the body lower end remaining open also allows free flow of rainwater or river/lake water that may fall into the mouth of the holder.

The carrier strap or sleeve is completely removable for the loading the holder by way of the full longitudinal slice in the sidewall. To minimize wear on the access slice, a fork-like tool is used to guide the leader filaments into the holder along the slice.

### CITED REFERENCES

| | | |
|---|---|---|
| 9,320,267 | 8,943,740 | 8,522.474 |
| 8,468,739 | 8,458,951 | 8,205,376 |
| 7,627,980 | 7,513,076 | 7,387,275 |
| 7,380,367 | 7,367,449 | 7,284,349 |
| 7,213,364 | 7,159,356 | 6,962,020 ! |
| 6,219,958 | 5,941,017 | 5,857,285 |
| 5,806,235 | 5,761,845 | 5,738,297 |
| 5,544,442 | 5,501,030 | 5,440,829 |
| 5,410,836 | 5,357,707 | 5,337,511 |
| 5,157,862 | 5,033,228 | 5,020,264 |
| 5,018,298 | 4,998,685 | 4,977,700 |
| 4,961,281 | 4,924,621 | 4,835,901 |
| 4,700,502 | 4,680,886 | 4,631,856 |
| 4,577,433 | 4,573,284 | 4,528,772 ! |
| 4,514,928 | 4,437,258 ! | 4,326,630 |
| 4,290,223 | 4,281,806 | 4,249,707 |
| 4,248,004 | 4,179,834 ! | 4,036,451 |
| 4,030,228 | 4,006,554 | 4,005,541 |
| 3,991,507 | 3,943,655 | |
| Foreign | JP 2006067990 | CA 1168044 |
| Applications | 20140083881 | 20130326932 |
| 20120233904 | 20080244957 | |
| 20050198891 ! | 20040074137 | |

### DRAWINGS AND DESCRIPTION

### Brief Summary of Drawings

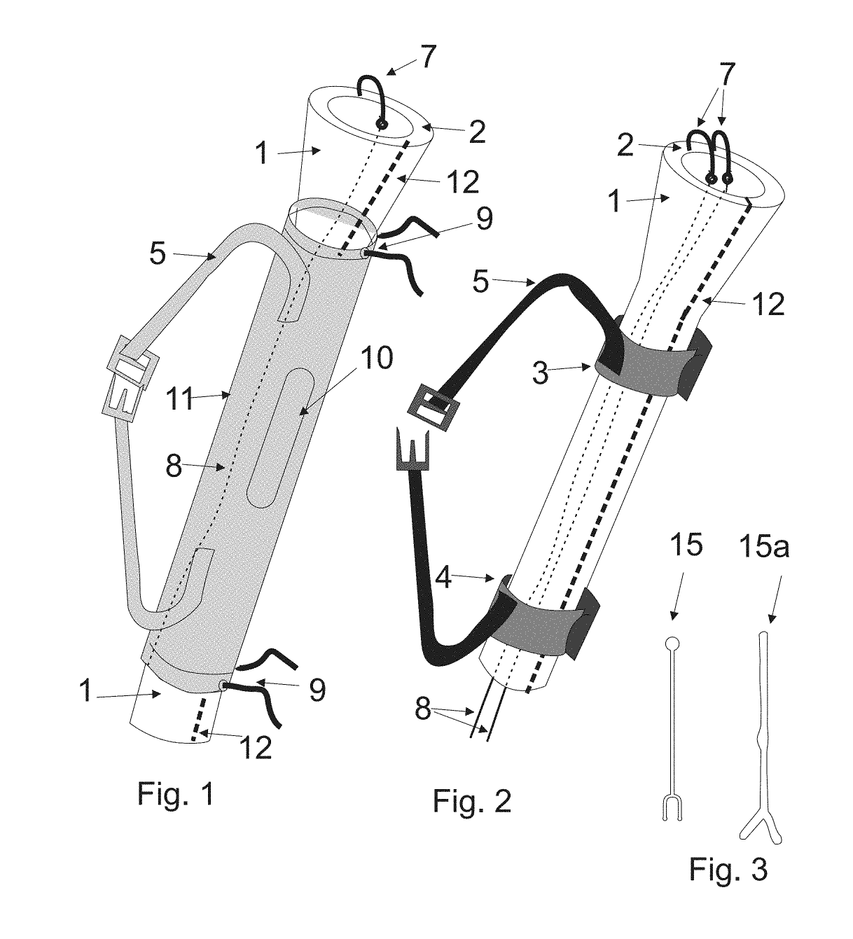

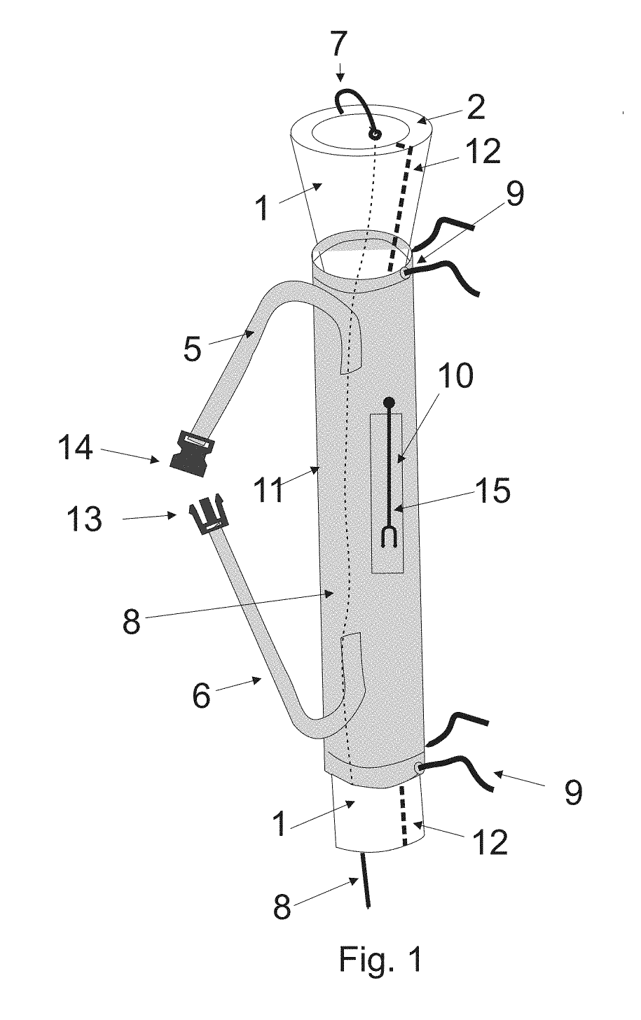

FIG. 1. is the embodiment of the device with a sleeve-like securing apparatus.

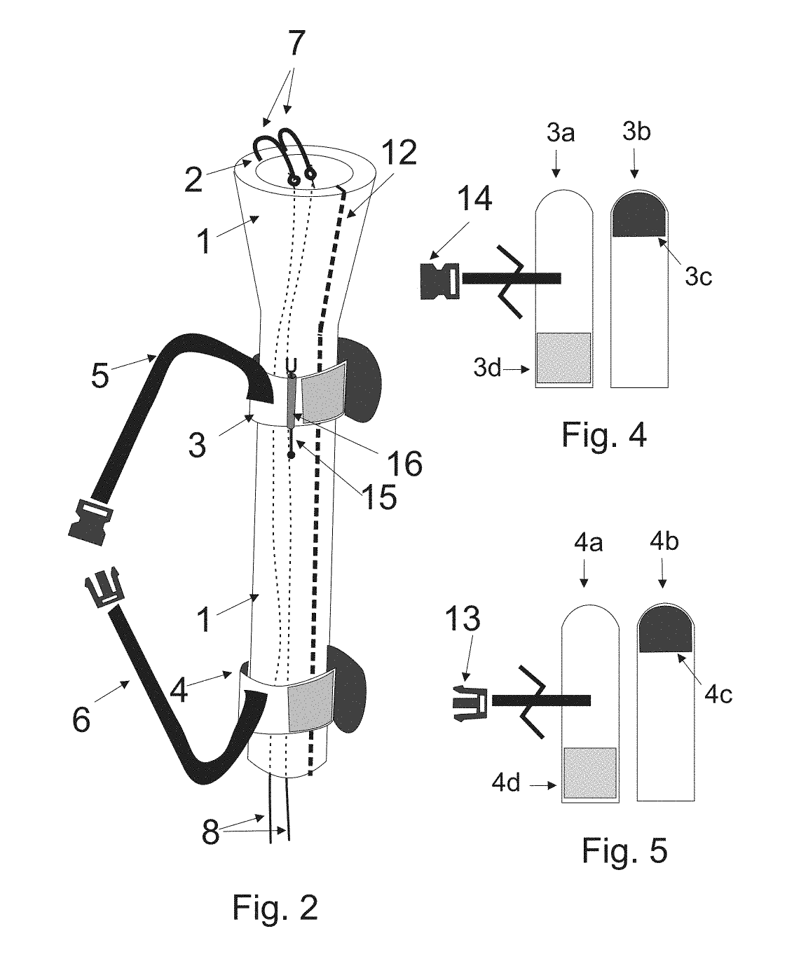

FIG. 2. is the embodiment of the device with a strap type securing apparatus

FIG. 3 is the tool that facilitates loading of the leader filaments into the body of the device.

FIG. 4 is the top piece configuration for the strap type securing apparatus.

FIG. 5 is the bottom piece configuration for the strap type securing apparatus.

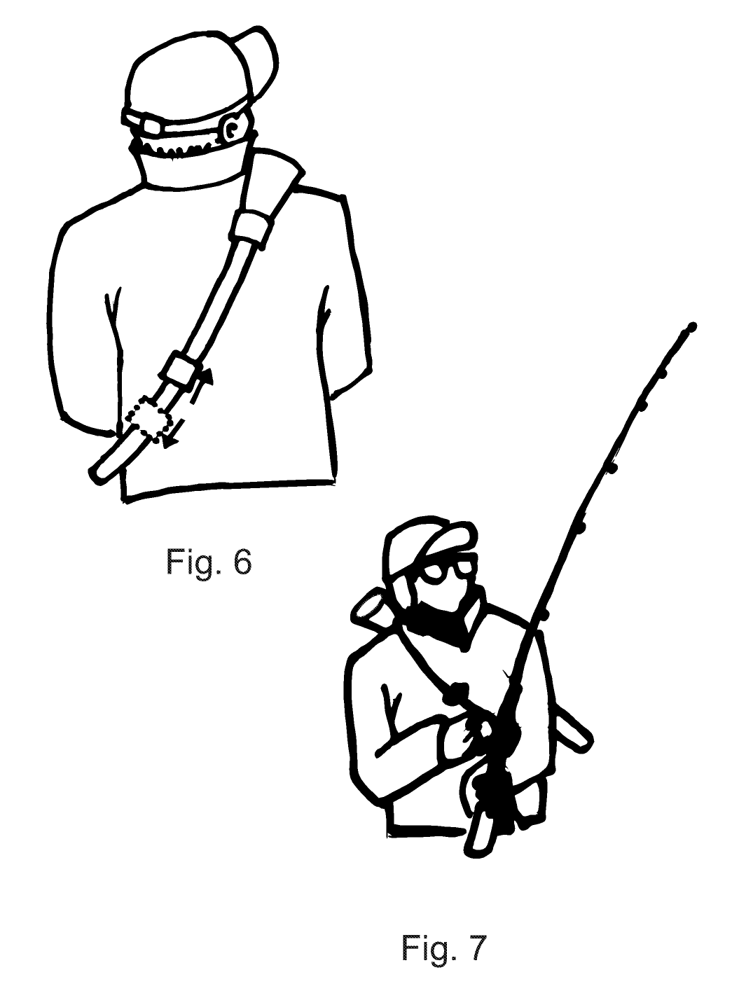

FIG. 6 is the view of the device being worn in the field from the rear.

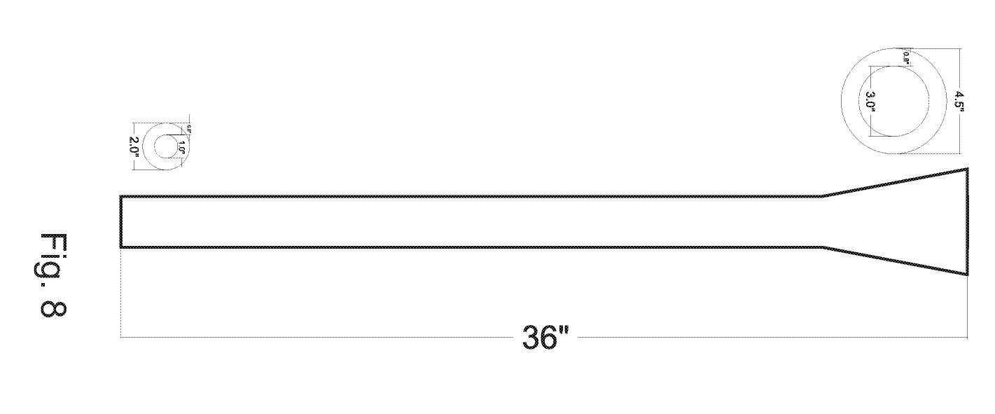

FIG. 7 the view of the device being worn in the field from the front.

FIG. 8 shows the overall dimensions of the preferred embodiment of the main body and mouth.

### DETAILED DESCRIPTION OF THE DRAWINGS

The quiver type fishing leader carrier, illustrated in FIG. 1, is comprised of a lightweight, flexible foam body (1) with a flared ‘mouth’ area (2) which holds the hooks. The body (1) has a full length longitudinal opening slice (12) to allow simple loading of the pre-tied hooks (7) and leader filaments (8) with a specialized tool with a shallow two tined, fork-like shape (15) or a simple small twig cut to the fork like configuration (15a).

FIG. 1 shows an embodiment of the invention wherein the securing (enveloping) apparatus is comprised of a removable sleeve (11) that slides onto the main body (1) after loading the pre-tied hooks (7) and leader filaments (8) into the body (1) with the tool (15 or 15a). The sleeve (11) is then fastened to the body (1) by means of two drawstring closures (9) that perform two functions; 1. That of securing the longitudinal opening (12) in a closed position, and 2. securing the adjustable carrying strap (5 & 6) to the main body of the invention. The adjustable strap (5) has a female snap buckle closure and the adjustable strap (6) has a male snap buckle closure, both top strap (5) and bottom strap (6) are adjustable to suit wearer size and bulky cold weather clothes. The sleeve may also incorporate a carry pouch (10) for the leader loading tool (5 or 5a).

The quiver type fishing leader carrier, illustrated in FIG. 2, is comprised of a lightweight, flexible foam body (1) with a flared ‘mouth’ area (2) which holds the hooks. The body (1) has a full length longitudinal opening slice (12) to allow simple loading of the pre-tied hooks (7) and leader filaments (8) with a specialized tool with a shallow two tined, fork-like shape (15) or a simple small twig cut to the fork like configuration (15a).

FIG. 2. shows the embodiment of the invention wherein the carrying apparatus is comprised of a removable set of hook and loop closure securing straps (3 & 4) that close around the main body in a circumference manner. The top securing strap (3) has the top carrying strap (5) attached to the outer side (3a) with the hook side of the hook and loop fastener (3d). The inner side (3b) of the top securing strap (3) has the loop (fabric) side of the hook and loop fastener. The Top carrying strap (5) is adjustable with the female side of the snap buckle closure (14).

The bottom securing strap (4) has the bottom carrying strap (6) attached to the outer side (4a) with the hook side of the hook and loop fastener (4d). The inner side (4b) of the bottom securing strap (6) has the loop (fabric) side of the hook and loop fastener. The bottom carrying strap (6) is adjustable with the male side of the snap buckle closure (13). The top securing strap (3) will have a small loop in the material of the securing strap (16) to hold the leader loading tool (15 or 15a).

1. An apparatus that holds and transports a plurality of pre-tied hooks and leaders especially when, but not limited to, fishing for river run salmon.

2. An apparatus that, in addition to 1, allows the ease of access to pre-tied hooks and leaders be ‘one movement’, likened to pulling an arrow from a quiver.

3. An apparatus that, in addition to 1, is flexible and pliant.

4. An apparatus that, in addition to 1, is waterproof and lightweight.

5. An apparatus that, in addition to 1, is shaped like an elongated funnel to shed rain water or river or lake water ingress.

6. An apparatus that, in addition to 1, prevents the kinking or curling or otherwise deforming of the desired straight nature of the leader filaments in their entirety.

7. An apparatus that, in addition to 1, is used in conjunction with a removable strap-like or sleeve-like containment component, and that component has attached, a carrying strap characterized by being without protuberances or dangling loose ends so that it sits flush to the wearers body to avoid entanglement, and having an adjustable component to accommodate differing persons sizes.
